(19) United States
(12) Patent Application Publication
(10) Pub. No.: US 2025/0162194 A1
(43) Pub. Date: May 22, 2025

(54) METHOD FOR PRODUCING A LAMINATE FROM WOOD AND A CURABLE COMPOSITION

(71) Applicants: SIKA TECHNOLOGY AG, Baar (CH); EMPA, Dübendorf (CH)

(72) Inventors: Steffen KELCH, Oberengstringen (CH); Urs BURCKHARDT, Zürich (CH); Tim MAMIE, Zürich Altstetten (CH); Ingo BURGERT, Zürich (CH); Philippe GRÖNQUIST, Zürich (CH); Sandro STUCKI, Felben-Wellhausen (CH); Andrea FRANGI, Rüschlikon (CH); Stefan VÖGTLI, Lupsingen (CH)

(73) Assignees: SIKA TECHNOLOGY AG, Baar (CH); EMPA, Dübendorf (CH)

(21) Appl. No.: 18/835,150

(22) PCT Filed: Jan. 25, 2023
(86) PCT No.: PCT/EP2023/051745

§ 371 Date: Aug. 1, 2024

(30) Foreign Application Priority Data
Feb. 7, 2022 (EP) 22155468.6

(51) Int. Cl. B27N 7/00; B05D 7/06; E04F 13/10

(52) U.S. Cl. CPC B27N 7/005; B05D 7/06; B05D 2203/20; B05D 2504/00; B05D 2601/20; E04F 13/10

(57) ABSTRACT

A method of producing a laminate, wherein a wood body is provided, a curable composition in the liquid state is applied thereto, and the composition cures, wherein the composition contains at least one organic binder and at least 80% by weight of mineral fillers, based on the overall composition. The method enables permanent bonding of wood bodies and compositions that are based on organic binder and have a high content of mineral fillers. The laminates obtained from the method are comparatively lightweight, stable and durable, and are particularly suitable as sustainable components in building construction, especially as a roof element.

### TECHNICAL FIELD

The invention relates to a method for producing a laminate, to a laminate, and to the use thereof as a component in building construction.

### PRIOR ART

Wood, which is a renewable raw material, has been used as building material since time immemorial and has additional benefits aside from sustainability over mineral building materials such as concrete, in particular high tensile strength coupled with low density and appealing esthetics. Disadvantages of wood as building material lie primarily in inadequate fire resistance and acoustic conductivity, which makes it difficult to achieve fire protection and sound insulation, and in swelling and shrinking characteristics under the influence of moisture. The combination of wood with a mineral building material as a hybrid system can combine the benefits of the two building materials with one another, in that wood can absorb the tensile forces and the mineral building material the compressive forces. This can be utilized, for example, for roof constructions that have high load-bearing capacity and flexural stiffness coupled with relatively low intrinsic weight and low overall height and can therefore also be used for large spans, coupled with good fire protection and sound insulation properties. For the achievement of such properties, it is crucial to bond wood and mineral building material, which are fundamentally different materials, with maximum shear resistance and permanence by a suitable bonding method, which has been attempted in various ways in the prior art.

The typical course of action in the bonding of wood to a mineral building material such as concrete is to bond a cured concrete body to the wood by means of metallic securing systems such as screws, bolts, clamps or anchors. Although such bonds are stable and durable, they are complex to produce and often visually unsatisfactory. A further option is to establish a mechanically stable interdigitation with the concrete by means of notches or slots in the wood, for example in that the liquid concrete cures in contact with the wood body. However, such bonds often have inadequate stability and durability, not least because of movements in the wood as a result of shrinkage or expansion owing to elevated humidity or mechanical stress.

The bonding of wood to cured concrete is also known. But the bonding typically requires a complex pretreatment of the concrete surface in which the cement skin on the concrete surface is mechanically removed in order to avoid disrupted curing of the adhesive and to assure a stable, durable bond.

WO 99/02796 and M. Brunner et al., Materials and Structures (2007) 40:119-126, describes the bonding of wood to concrete by means of an adhesive in a wet-on-wet method, and the difficulties that occur. The laminates thus obtained break under mechanical stress, or often do so at the adhesive interfaces as a result of the swelling and shrinking characteristics of the wood with varying humidity. Moreover, the curing reaction of the adhesive is often disrupted by the fresh concrete such that insufficient bond strengths are built up and hence the result is not a durable and/or permanent bond.

### SUMMARY OF THE INVENTION

It is an object of the present invention to provide a hybrid system comprising wood and a mineral building material that is easily producible, is suitable as building element in building construction, and overcomes the disadvantages of the prior art. This object is surprisingly achieved by a method for producing a laminate as described in claim 1. This involves overlayering a wood body with a curable composition applied in liquid form, containing at least one organic binder, preferably one based on epoxy resin or polyisocyanate, and at least 80% by weight of mineral fillers.

The method of the invention is easily and rapidly performable. The composition applied in liquid form cures rapidly, shows barely any shrinkage, can be subjected to early stress and does not release any moisture or wetness like mineral building materials that set in a cementitious fashion. Even without complex pretreatment of the wood surface, the result is excellent adhesion of the cured composition on the wood body. The resultant laminate is mechanically durable and impact-resistant. Even in the case of a low layer thickness of the composition applied and without reinforcement with steel, weaves or fibers, it has high compressive strength and high vibration stiffness. Moreover, it exhibits a low coefficient of thermal expansion, good thermal insulation properties and no sensitivity to corrosion, and is particularly insensitive to the action of moisture or frost, with effective impregnation of the wood body by the impervious cured composition.

The method of the invention enables the production of laminates of excellent suitability as sustainable components in building construction, especially as roof elements, where there are high demands in relation to esthetics, sound insulation, strength and stability. In addition, the method of the invention enables the use of hardwood in the construction sector, which is often unusable because of its high tendency to absorb water by comparison with softwood, especially in combination with fresh concrete. The composition used in the method of the invention also acts a a moisture barrier and protects the wood side of the laminate from water penetrating from above. The laminates obtained from the method are comparatively lightweight, stable and durable, and are particularly suitable as sustainable components in building construction, especially as a roof element. Further aspects of the invention are the subject of further independent claims. Particularly preferred embodiments of the invention are the subject of the dependent claims.

### Ways of Executing the Invention

The invention provides a method of producing a laminate, characterized in that
a wood body is provided,
a curable composition in the liquid state is applied thereto,
and the composition cures,
   wherein the composition contains at least one organic binder and at least 80% by weight of mineral fillers, based on the overall composition.

“Mineral filler” refers to a pulverulent or grainy inorganic material.

“Slag” refers to a material that solidifies in glassy or crystalline form and is formed as a by-product, especially in the recovery of metals in ore smelting, in metal recycling or in the incineration of waste, and is suitable as a mineral filler in comminuted form. This is a substance mixture having, as its main constituents, CaO, SiO₂, Al₂O₃, MgO and FeO.

Substance names beginning with “poly”, such as polyamine or polyol, refer to substances containing, in a formal sense, two or more of the functional groups that occur in their name per molecule.

“Amine hydrogen” refers to the hydrogen atoms of primary and secondary amino groups.

“Molecular weight” refers to the molar mass (in grams per mole) of a molecule. “Average molecular weight” refers to the number-average M, of a polydisperse mixture of oligomeric or polymeric molecules, which is typically determined by gel-permeation chromatography (GPC) against polystyrene as standard.

A “storage stable” composition refers to one that can be stored at room temperature in a suitable container over a prolonged period, typically over at least 3 months up to 6 months or more, without this storage resulting in any change to an extent relevant to its use.

The “pot life” of a curable composition refers to the maximum period of time between the mixing of the components until the application, in which the mixed composition is in a sufficiently free-flowing state and has good ability to wet the wood surface.

“Room temperature” refers to a temperature of 23° C.

All industry standards and norms mentioned in this document refer to the versions valid at the date of first filing, unless otherwise stated.

Percentages by weight (% by weight) refer to the proportions by mass of a constituent in a composition based on the overall composition, unless otherwise stated. The terms “mass” and “weight” are used synonymously in the present document.

The wood body preferably consists of hardwood or softwood, preferably beechwood or sprucewood. These types of wood are mechanically durable and are widely used in the building industry.

In particular, the wood body consists of beechwood. This is widely available and particularly hard and durable. But because of its high swellability under the influence of moisture, it has been used comparatively rarely to date as building material.

Suitable wood bodies are all kinds of shaped bodies made of wood. Preference is given to shaped bodies having at least one flat face.

The wood body is preferably provided such that a horizontal, flat face faces upward, also referred to hereinafter as “top side”

The wood body preferably has the shape of a cube or cuboid, especially a cuboid. In the case of a cuboid, it is preferably positioned such that one of the largest faces is at the top and hence forms the top side. The side at right angles to the top side is also referred to hereinafter as “thickness”.

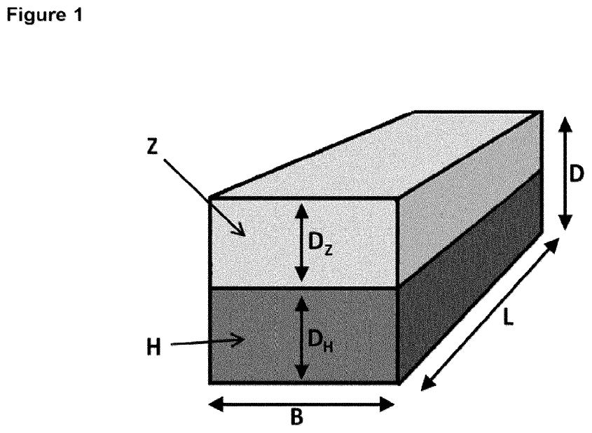

The wood body preferably has a thickness in the range from 10 to 300 mm, preferably 20 to 200 mm. The thickness of the wood body (H) is shown by way of example in FIG. 1, labeled D_{H}.

The top side of the wood body preferably has a length in the range from 0.3 to 20 m, particularly preferably 1 to 10 m. The length of the wood body (H) is shown by way of example in FIG. 1, labeled L.

The top side of the wood body preferably has a width in the range from 50 to 2000 mm, preferably 150 to 1500 mm, especially 150 to 1000 mm. The width of the wood body (H) is shown by way of example in FIG. 1, labeled B.

The wood body preferably has the shape of a cuboid, where the length is greater than the width and the width is greater than the thickness. Such a wood body may also be referred to as a board, beam or bar.

The wood body may consist of unglued solid wood.

The wood body preferably consists of glued and/or interdigitated laminated wood consisting of laminas or square rods. This enables large wood bodies of high mechanical durability and dimensional stability, especially wood bodies of length 1 m or more and width 150 mm or more.

The word is preferably in a dry, stored state as typical for use as building material.

The wood body may be pretreated prior to the applying of the curable composition.

The wood body is preferably freed of dust.

Mechanical pretreatment in the form of roughening or machining of grooves or slits is possible, but is unnecessary for good bonding and hence not preferred. Pretreatment by activators or primers is possible. For an epoxy resin-based curable composition in particular, however, pretreatment by activators or primers is unnecessary for good adhesion.

Preferably, the wood body on application of the liquid curable composition has been provided with formwork elements on the outer sides, for example in an extension of the lateral edges, such that the composition remains on the wood body after the application and cannot flow away. In FIG. 1, the thickness D_{H} of the wood body (H) is apparent by way of example. The formwork elements are preferably mounted such that they enclose the thickness D_{H} of the wood body and project upward to such an extent that they form a complete formwork in the case of complete filling of the volume formed with the liquid composition. The height of the formwork elements preferably corresponds to the thickness D of the laminate, as shown by way of example in FIG. 1.

Suitable formwork elements are boards or other devices that are removed after the curable composition has hardened, as customary in concrete construction.

Preferably, the curable composition comprises at least two separately packed components that are mixed before or during the applying of the liquid composition.

The curable composition is preferably free of cement.

The liquid composition on application preferably has a largely self-leveling, readily castable consistency in order to sufficiently wet the surface of the wood body. On application, the preferably mounted formwork elements prevent the composition applied from flowing away. The formwork elements together with the top side of the wood body preferably form a casting mold in which the top side of the wood body forms the base. The formwork elements preferably project above the top side of the wood body to such an extent that the depth of the casting mold corresponds to the desired layer thickness of the curable composition.

Preferably, the curable composition is applied in a layer thickness in the range from 10 to 300 mm, preferably 20 to 200 mm, especially 30 to 100 mm. The layer thickness of the curable composition (Z) is shown by way of example in FIG. 1, labeled D_{Z}.

The curable composition is preferably applied so as to form a horizontal surface. Optionally, the surface composition is smoothed toward the end of the application, for example by means of a spatula or brick trowel. In addition, it is possible to use a spiked roller in order to burst and hence to eliminate the air bubbles present on the surface. The curable composition is preferably applied within the pot life.

This is preferably followed by the curing of the curable composition applied.

The composition is preferably cured at ambient temperature, optionally under the action of moisture. The organic binder crosslinks here via chemical reaction of the reactive groups present. The duration of the curing process is dependent on the ambient conditions and the ingredients used in the curable composition. Typically, formwork elements present are removed after about 12 to 24 hours, and the laminate attains its final strength after a few days or weeks at room temperature.

Suitable organic binders of the curable composition are all kinds of organic binders, especially those based on epoxy resins, polyisocyanates, polymers that crosslink via silane groups, unsaturated polyester resins, acrylic resins or further polymers having crosslinkable reactive groups.

The organic binder, prior to application, is preferably divided into at least two separately packed, storage-stable components, where the mineral filler may be present at least partly as an additional, separately packed component. It is alternatively possible that the organic binder is present in just one separately packed component, where some of the reactive groups of the organic binder in particular are in blocked form and are released, for example, by hydrolysis during and after application by the action of moisture, and/or the reactive groups of the organic binder undergo crosslinking by the action of moisture, as in the case of polyisocyanates in particular.

Preferably, the organic binder of the curable composition is selected from a) epoxy resins and curing agents for epoxy resins and b) polyisocyanates and crosslinkers for polyisocyanates. Such compositions enable rapid curing, high bond strengths on the wood body and good mechanical properties of the resultant laminate without deformation of the wood body as a result of shrinkage or incompatibility.

In a particularly preferred embodiment of the invention, the organic binder in the curable composition comprises at least one epoxy resin and at least one curing agent for epoxy resins. Such a composition enables excellent adhesion of the cured composition on the wood body without requiring pretreatment of the wood surface with activators or primers, which means that the method of the invention is performable in a particularly simple manner. Moreover, such a composition in the performance of the method is particularly insensitive to moisture, for example in the form of high air humidity or an elevated moisture content of the wood body. This also simplifies the performance of the method.

Such a curable composition preferably comprises
a first component comprising at least one epoxy resin, especially selected from bisphenol A diglycidyl ethers, bisphenol F diglycidyl ethers and phenol novolac glycidyl ethers having an average functionality of 2.3 to 3,
and a second component comprising the curing agent for epoxy resins, containing at least one polyamine having aliphatically bonded amino groups and at least 3 amine hydrogens,
   and the mineral filler is present as a constituent of the first and/or second component and/or as a further component.

Suitable epoxy resins are especially liquid epoxy resins. These are technical grade epoxy resins that are free-flowing at room temperature and have a glass transition temperature of below 25° C. These are obtained in a known manner, more particularly from the glycidylation of compounds having at least two active hydrogen atoms, more particularly polyphenols, polyols or amines, through reaction with epichlorohydrin.

Suitable epoxy resins are especially aromatic liquid epoxy resins, especially the glycidyl ethers of:
bisphenol A, bisphenol F or bisphenol A/F, where A stands for acetone and F for formaldehyde used as reactants in the production of these bisphenols. In the case of bisphenol F, positional isomers may also be present, more particularly ones derived from 2,4′- or 2,2′-hydroxyphenylmethane.
dihydroxybenzene derivatives such as resorcinol, hydroquinone or catechol;
further bisphenols or polyphenols such as bis(4-hydroxy-3-methylphenyl)methane, 2,2-bis(4-hydroxy-3-methylphenyl)propane (bisphenol C), bis(3,5-dimethyl-4-hydroxyphenyl)methane, 2,2-bis(3,5-dimethyl-4-hydroxyphenyl)propane, 2,2-bis(3,5-dibromo-4-hydroxyphenyl)propane, 2,2-bis(4-hydroxy-3-tert-butylphenyl)propane, 2,2-bis(4-hydroxyphenyl)butane (bisphenol B), 3,3-bis(4-hydroxyphenyl)pentane, 3,4-bis(4-hydroxyphenyl)hexane, 4,4-bis(4-hydroxyphenyl)heptane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane (bisphenol Z), 1,1-bis(4-hydroxyphenyl)-3,3,5-trimethylcyclohexane (bisphenol TMC), 1,1-bis(4-hydroxyphenyl)-1-phenylethane, 1,4-bis[2-(4-hydroxyphenyl)-2-propyl]benzene (bisphenol P), 1,3-bis[2-(4-hydroxyphenyl)-2-propyl]benzene (bisphenol M), 4,4-dihydroxydiphenyl (DOD), 4,4′-dihydroxybenzophenone, bis(2-hydroxynaphth-1-yl)methane, bis(4-hydroxynaphth-1-yl)methane, 1,5-dihydroxynaphthalene, tris(4-hydroxyphenyl)methane, 1,1,2,2-tetrakis(4-hydroxyphenyl)ethane, bis(4-hydroxyphenyl) ether or bis(4-hydroxyphenyl) sulfone:
novolacs, which are especially condensation products of phenol or cresols with formaldehyde or paraformaldehyde or acetaldehyde or crotonaldehyde or isobutyraldehyde or 2-ethylhexanal or benzaldehyde or furfural;
aromatic amines such as aniline, toluidine, 4-aminophenol, 4,4′-methylenediphenyldiamine, 4,4′-methylenediphenyldi(N-methyl)amine, 4,4′-[1,4-phenylenebis(1-methylethylidene)]bisaniline (bisaniline P) or 4,4′-[1,3-phenylenebis(1-methylethylidene)]bisaniline (bisaniline M).

Further possible epoxy resins are aliphatic or cycloaliphatic polyepoxides, especially
glycidyl ethers of saturated or unsaturated, branched or unbranched, cyclic or open-chain di-, tri- or tetrafunctional C₂ to C₃₀ alcohols, especially ethylene glycol, propylene glycol, butylene glycol, hexanediol, octanediol, polypropylene glycols, dimethylolcyclohexane, neopentyl glycol, dibromoneopentyl glycol, castor oil, trimethylolpropane, trimethylolethane, pentaerythritol, sorbitol or glycerol, or alkoxylated glycerol or alkoxylated trirnethylolpropane;
a hydrogenated bisphenol A, F or A/F liquid resin or the glycidylation products of hydrogenated bisphenol A, F or A/F;
an N-glycidyl derivative of amides or heterocyclic nitrogen bases, such as triglycidyl cyanurate or triglycidyl isocyanurate, or reaction products of epichlorohydrin with hydantoin.

Preference is given to aromatic liquid epoxy resins, especially having an average epoxy equivalent weight in the range from 156 to 210 g/eq.

The epoxy resin is preferably selected from bisphenol A diglycidyl ethers, bisphenol F diglycidyl ethers and phenol novolac glycidyl ethers having an average functionality of 2.3 to 3. These have a readily manageable viscosity and enable curable compositions having good processability and high strength and durability after curing.

Preference is further given to epoxy resins based at least partly on renewable raw materials, especially epoxy resins from the reaction of biobased hydroxy-functional compounds with biobased epichlorohydrin. Particular preference is given to vanillin-based epoxy resins such as, in particular, vanillin alcohol diglycidyl ether or the glycidyl ethers of bisvanillin derivatives, and glycerol-based epoxy resins such as, in particular, the glycidyl ethers of glycerol or polyglycerol. Such epoxy resins enable particularly sustainable laminates.

The first component in this embodiment preferably contains at least one reactive diluent containing epoxy groups, such as, in particular, butanediol diglycidyl ether, hexanediol diglycidyl ether, trimethylolpropane di- or triglycidyl ether, phenyl glycidyl ether, cresyl glycidyl ether, guaiacol glycidyl ether, 4-methoxyphenyl glycidyl ether, p-n-butylphenyl glycidyl ether, p-tert-butylphenyl glycidyl ether, 4-nonylphenyl glycidyl ether, 4-dodecylphenyl glycidyl ether, cardanol glycidyl ether, benzyl glycidyl ether, allyl glycidyl ether, butyl glycidyl ether, hexyl glycidyl ether, 2-ethylhexyl glycidyl ether, or glycidyl ethers of natural alcohols, such as, in particular, C₆ to C₁₀ or C₁₂ to C₁₄ or C₁₃ to C₁₅, alkyl glycidyl ethers. Preference is given to butanediol diglycidyl ether, hexanediol diglycidyl ether, C₁₂-to C₁₄-alkyl glycidyl ethers or a combination of these reactive diluents.

The second component in this embodiment, containing the curing agent for epoxy resins, contains at least one polyamine having aliphatically bonded amino groups and at least 3 amine hydrogens.

Suitable polyamines of this kind are especially N-benzylethane-1,2-diamine, N-benzylpropane-1,2-diamine, N-benzyl-1,3-bis(aminomethyl)benzene, N-(2-ethylhexyl)-1,3-bis(aminomethyl)benzene, 2,2-dimethylpropane-1,3-diamine, pentane-1,3-diamine (DAMP), pentane-1,5-diamine, 1,5-diamino-2-methylpentane (MPMD), 2-butyl-2-ethylpentane-1,5-diamine (C11-neodiamine), hexane-1,6-diamine, 2,5-dimethylhexane-1,6-diamine, 2,2(4),4-trimethylhexane-1,6-diamine (TMD), heptane-1,7-diamine, octane-1,8-diamine, nonane-1,9-diamine, decane-1,10-diamine, undecane-1,11-diamine, dodecane-1,12-diamine, 1.2-, 1,3- or 1,4-diaminocyclohexane, 1,3-bis(aminomethyl)cyclohexane, 1,4-bis(aminomethyl)cyclohexane, bis(4-aminocyclohexyl)methane, bis(4-amino-3-methylcyclohexyl)methane, bis(4-amino-3-ethylcyclohexyl)methane, bis(4-amino-3,5-dimethylcyclohexyl)methane, bis(4-amino-3-ethyl-5-methylcyclohexyl)methane, 1-amino-3-aminomethyl-3,5,5-trimethylcyclohexane (IPDA), 2(4)-methyl-13-diaminocyclohexane, 2,5(2,6)-bis(aminomethyl)bicyclo[2.2.1]heptane (NBDA), 3(4),8(9)-bis(aminomethyl)tricyclo[5.2.1.0^{2,6}]decane, 1,4-diamino-2,2,6-trimethylcyclohexane (TMCDA), menthane-1,8-diamine, 3,9-bis(3-aminopropyl)-2,4,8,10-tetraoxaspiro[5.5]undecane, 1,3-bis(aminormethyl)benzene (MXDA), 1,4-bis(aminomethyl)benzene, bis(2-aminoethyl) ether, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine, 4,7,10-trioxatridecane-1,13-diamine or higher oligomers of these diamines, bis(3-aminopropyl)polytetrahydrofurans or other polytetrahydrofurandiamines, polyoxyalkylenedi- or -triamines, in particular polyoxypropylenediamines or polyoxypropylenetriamines such as Jeffamine® D-230, Jeffamine® D-400 or Jeffamine® T-403 (all from Huntsman), furan-based amines such as 2,5-bis(aminomethyl)furan, 2,5-bis(aminomethyl)tetrahydrofuran, bis(5-aminomethylfuran-2-yl)methane, bis(5-aminomethyltetrahydrofuran-2-yl)methane, 2,2-bis(5-aminomethylfuran-2-yl)propane or 2,2-bis(5-aminomethyltetrahydrofuran-2-yl)propane, or diethylenetriamine (DETA), triethylenetetramine (TETA), tetraethylenepentamine (TEPA), pentaethylenehexamine (PEHA), dipropylenetriamine (DPTA), N-(2-aminoethyl)propane-1,3-diamine (N3 amine), N,N′-bis(3-aminopropyl)ethylenediamine (N4 amine), N,N-bis(3-aminopropyl)-1,4-diaminobutane, N5-(3-aminopropyl)-2-methylpentane-1,5-diamine, N3-(3-aminopentyl)pentane-1,3-diamine, N5-(3-amino-1-ethylpropyl)-2-methylpentane-1,5-diamine, N,N′-bis(3-amino-1-ethylpropyl)-2-methylpentane-1,5-diamine, 3-(2-aminoethyl)aminopropylamine, bis(hexamethylene)triamine (BHMT), N-aminoethylpiperazine, 3-dimethylaminopropylamine (DMAPA), 3-(3-(dimethylamino)propylamino)propylamine (DMAPAPA), amine-functional adducts of the amines mentioned with epoxides, phenalkamines, which are reaction products of cardanol with aldehydes, in particular formaldehyde, and polyamines, polyamidoamines such as, in particular, reaction products of a dimer fatty acid with a stoichiometric excess of a polyamine such as, in particular, DETA, TETA or TEPA.

The curing agent preferably contains a combination of two or more such polyamines.

Preferred polyamines are MPMD, TMD, 1,2-diaminocyclohexane, 1,3-bis(aminomethyl)cyclohexane, 1,4-bis(aminomethyl)cyclohexane, bis(4-aminocyclohexyl)methane, IPDA, 2(4)-methyl-1,3-diaminocyclohexane, MXDA, DETA, TETA, TEPA, N3 amine, N4 amine, DPTA, polyoxypropylenedi- or -triamines having an average molecular weight M, in the range from 200 to 500 g/mol or polyamidoamines, and in particular combinations of these amines.

An epoxy resin-based curable composition preferably contains further ingredients, especially fillers such as benzyl alcohol or catalysts such as calcium nitrate, sulfonic acids or amines containing phenol groups, such as, in particular, 2,4,6-tris(dimethylaminomethyl)phenol, or other substances that are customarily used in epoxy resin compositions.

Preferably neither the epoxy resin nor the curing agent is water-based. Such a curable composition preferably contains only a small water content, preferably of less than 5% by weight, especially less than 1% by weight, of water, based on the overall composition. Such a composition is particularly stable after curing.

The components of such an epoxy resin-based composition are preferably mixed in such a ratio that the molar ratio of the amine hydrogens to the epoxy groups is in the range from 0.5 to 1.5, especially 0.7 to 1.2. Such a composition cures rapidly and without disruption.

In a further preferred embodiment of the invention, the organic binder in the curable composition comprises at least one polyisocyanate and at least one crosslinker for polyisocyanates. Such a composition cures particularly rapidly, which enables a particularly efficient method.

Such a curable composition preferably comprises
a first component comprising a crosslinker for polyisocyanates, containing at least one polyol having an average molecular weight of 250 to 2000 g/mol and an average OH functionality of 1.7 to 6,
and a second component comprising at least one polyisocyanate,
   and the mineral filler is present as a constituent of the first and/or second component and/or as a further component.

Preference is given to polyols that are liquid at room temperature.

Preference is given to conventional polyols as typically used for polyurethane compositions, especially polyether polyols, polyester polyols, polycarbonate polyols, polyacrylate polyols, polyols derived from natural fats or oils such as castor oil in particular, or reaction products of castor oil with ketone resins, polyhydrocarbon polyols such as polybutadiene polyols, and combinations of such polyols.

Preference is given to polyols having an average molecular weight of 250 to 1000 g/mol.

Preference is given to polyols having an average OH functionality of 1.8 to 4.

The first component preferably contains at least one further crosslinker, such as, in particular, ethane-1,2-diol, propane-1,3-diol, 2-methylpropane-1,3-diol, butane-1,4-diol, pentane-1,5-diol, neopentyl glycol, hexane-1,6-diol, 3-methylpentane-1,5-diol, heptane-1,7-diol, octane-1,8-diol, cyclohexane-1,3-dimethanol, cyclohexane-1,4-dimethanol, diethylene glycol or triethylene glycol, or further di- or polyfunctional alcohols, such as, in particular, ethoxylated bisphenol A, propoxylated bisphenol A, cyclohexanediol, hydrogenated bisphenol A, dimer fatty acid alcohols, 1,1,1-trimethylolethane, 1,1,1-trimethylolpropane, glycerol, pentaerythritol, sugar alcohols such as, in particular, xylitol, sorbitol or mannitol, or sugars such as, in particular, sucrose, or alkoxylated derivatives of the alcohols mentioned or mixtures of the alcohols mentioned.

In addition, the first component may contain further crosslinkers such as, in particular, compounds containing amine groups or di- or polyfunctional aldimines or ketimines.

Suitable polyisocyanates are in particular diisocyanates, oligomers or polymers or derivatives of diisocyanates, isocyanate-containing reaction products of diisocyanates with polyols or combinations thereof.

Suitable diisocyanates are especially toluene diisocyanate (TDI), diphenylmethane diisocyanate (MDI), mixtures of MDI and MDI homologs (polymeric MDI or PMDI), hexane 1,6-diisocyanate (HDI), 2,2(4),4-trimethylhexane 1,6-diisocyanate (TMDI), 1-methyl-2,4(6)-diisocyanatocyclohexane (H₆TDI), isophorone diisocyanate (IPDI) or perhydro(diphenylmethane diisocyanate) (H₁₂MDI).

The polyisocyanate is preferably a form of NDI which is liquid at room temperature, especially a polymeric MDI, a partially carbodiimidized MDI or a quality of MDI having a high 2,4′-MDI content. These polyisocyanates are easily processible and/or enable particularly high strengths.

A polyisocyanate-based curable composition preferably contains further ingredients, especially solvents or thinners, catalysts for the crosslinking reaction, desiccants such as molecular sieves, adhesion promoters such as, in particular, silanes or titanates, or other substances that are customarily used in polyurethane compositions.

A polyisocyanate-based curable composition may contain a small amount of water, especially from 0.005% to 0.1% by weight of water, based on the overall composition. This can achieve a certain degree of foaming of the composition in the course of curing, which can have a positive effect on the properties of the laminate. The water may be present as a constituent of the first component or be added in another form in the course of mixing of the components.

The components of such a polyisocyanate-based composition are preferably mixed in such a ratio that the molar ratio of the hydroxyl groups and any other isocyanate-reactive groups present to the isocyanate groups is in the range from 0.7 to 1.1, preferably 0.8 to 1.0. Such a composition cures rapidly and without disruption.

The curable composition in all embodiments contains at least 80% by weight of mineral fillers. These may take the form of a separate component and may be mixed with the rest of the composition during or after the application, and/or they may be in preformulated form with further constituents of the composition.

In the case of the above-described epoxy resin-based or polyisocyanate-based compositions comprising a first component and a second component, the mineral fillers are present as a constituent of the first and/or second component and/or of a further component.

Preferably at least a portion of the mineral fillers is present as a separate third component, and optionally also as a further, fourth component.

The curable composition preferably contains at least 85% by weight of mineral fillers based on the overall composition. This enables release of a particularly small amount of heat in the course of curing, and particularly low shrinkage in the course of curing, which prevents warpage of the laminate.

A suitable mineral filler is in particular ground quartz, quartz sand, limestone sand, river sand, aggregate, slag, calcium carbonate, chalk, heavy spar (baryte), dolomite, wollastonite, talc, titanium dioxide, iron oxides, calcined pebbles, clay minerals, pumice, perlite, limestone, ground limestone, silica dust, aluminum oxide, cement, fly ash, metakaolin, silica fume, calcium sulfate or a combination of these. The shapes and sizes may vary from finely ground material through sand particles or pebbles up to large rocks.

If the curable composition contains hydraulic binders such as cement, these take the form of fillers, and the composition cures even without these.

The curable composition is preferably free of cement.

The mineral filler is preferably quartz and/or slag.

The curable composition preferably contains at least 50% by weight of mineral fillers selected from quartz and slag, based on the overall composition. Such a composition has good processibility and enables particularly high strengths.

The curable composition may contain further ingredients, especially
fibers, especially glass fibers, carbon fibers, metal fibers, ceramic fibers or polymer fibers such as polyamide fibers or polyethylene fibers,
rheology modifiers, especially thickeners,
surface-active additives, especially defoamers, deaerating agents, wetting agents, dispersants or levelling agents, or
stabilizers against oxidation, heat, light or UV radiation or biocides;

In a preferred embodiment of the invention, at least a portion of the mineral fillers has been coated with at least one dispersant, especially a polycarboxylate ether. This enables particularly good flowability of the curable composition even in the case of a high content of mineral fillers, and hence also particularly low exothermicity in the course of curing and a particularly high strength of the cured composition.

Polycarboxylate ethers are preferably present in the form of comb polymers containing carboxylic acid groups and/or salts thereof and poly(oxyalkylene) side chains. Such polycarboxylate ethers are known as plasticizers for mortars, for example, and are commercially available, for example under the Viscocrete® brand name (from Sika).

For coating of the mineral fillers, the dispersant may be sprayed on, or it may be mixed with the mineral fillers, optionally in dilute form.

The invention further provides a laminate obtained from the method of the invention.

The laminate comprises a wood layer and a layer consisting of the cured composition described. In particular, the laminate consists of a) the wood layer and b) the layer of the cured composition.

The laminate preferably has the shape of a cuboid.

FIG. 1 shows a laminate as just described for illustrative purposes. This comprises a wood layer (H) and a layer of the composition described (Z).

The bottom side of the cuboid is preferably formed by the wood side, and the top side of the cuboid by the cured composition. The thickness of the wood layer is preferably equal to or greater than the thickness of the composition. FIG. 1 shows, by way of example, the thickness (D_{H}) of the wood layer (H) and the thickness (D_{Z}) of the composition (Z).

The dimensions of the laminate are preferably such that the wood layer is capable of supporting the layer of the composition applied without being bent to a significant degree under its weight if there is no support, strengthening or reinforcement.

The laminate preferably has a load-bearing capacity of at least 100 kN, preferably at least 120 kN, determined on a laminate of dimensions 5200×320×180 mm composed of wood and the cured composition, where the wood layer has dimensions of 5200×320×120 mm and the cured composition dimensions of 5200×320×60 mm, by means of 4-point bending with two pressure cylinders at a testing span of 5000 mm, distance between the pressure cylinders before the sample was laid on in each case 1680 mm and distance between the pressure cylinders 1640 mm.

The maximum deformation is preferably in the range from 70 to 250 mm, especially 100 to 200 mm.

The stiffness of the composite cross section is preferably at least 10⁹ N/mm² especially 10¹¹ N/mm².

The laminate is stable and durable. It can especially be transported freely in space without permanent bending. It can be stacked and can come into contact with heat, humidity or UV light without suffering significant losses of stability.

The laminate may also be referred to as a board, beam, bar or sandwich element.

The laminate differs from a bonded article. In the laminate of the invention, the cured composition is in contact with the area of the wood layer only on one side. In the case of an article bonded with a cured composition, by contrast, the composition is disposed between at least two substrates with which the composition is in contact and which are bonded by the composition.

The invention further provides for the use of the laminate as a component in building construction, especially as roof element. The laminate is especially installed as a roof element such that the wood side forms the visible ceiling from the interior, and the side of the cured composition is directed toward the roof or an upper story.

The laminate from the method of the invention enables the installation of load-bearing wooden ceilings that are particularly sound- and heat-insulating and stable, require no hydraulic binders and only a low level of admixtures, and hence are particularly sustainable.

### EXAMPLES

Working examples are adduced hereinafter, which are intended to further elucidate the invention described. It will be apparent that the invention is not limited to these described working examples.

“Standard climatic conditions” (“SCC”) refer to a temperature of 23±41° C. and a relative air humidity of 50±5%,

The beechwood bodies used were square-rod laminated beechwood and came from Fagus Suisse SA.

### Curable Compositions Used:

### Composition Z1 (Epoxy Resin-Based):

Sikadur® 42 LE Plus component A (from Sika), reactively diluted epoxy resin based on bisphenol A/F diglycidyl ether.

Sikadur® 42 LE Plus component B (from Sika), curing agent for epoxy resins, containing isophoronediamine, polyetheramine, triethylenetetramine and benzyl alcohol.

Sikadur® 42 LE Plus component C (from Sika), mixture of mineral fillers containing about 75% by weight of quartz.

For the application, the liquid components A and B and the powder component C were mixed in a weight ratio A:B:C=3:1:32 and processed within 60 min.

### Composition Z2 (Epoxy Resin-Based):

Sikadur® 42 LE Plus component A (from Sika), reactively diluted epoxy resin based on bisphenol A/F diglycidyl ether.

Sikadur® 42 LE Plus component B (from Sika), curing agent for epoxy resins, containing isophoronediamine, polyetheramine, triethylenetetramine and benzyl alcohol.

Sikadur® 42 LE Plus component C (from Sika), mixture of mineral fillers containing about 75% by weight of quartz.

2.0 to 3.2 mm quartz sand, abbreviated to “OS”.

For the application, the liquid components A and B, the powder component C and quartz sand QS were mixed in a weight ratio A:B:C:QS=3:1:22:11 and processed within 60 min.

### Composition Z3 (Polyisocyanate-Based):

SikaBiresin® F50 component A (from Sika), polyol mixture with about 25% by weight of aluminum hydroxide and about 5% by weight of molecular sieve.

SikaBiresin® F50 component B (from Sika), liquid MDI.

Sikadur® 514 Plus component C (from Sika), mixture of mineral fillers containing about 70% by weight of quartz and about 15% by weight of portland cement.

For the application, the liquid components A and B and the powder component C were mixed in a weight ratio A:B:C=2:1:20 and processed within 30 min.

Composition Z4 (polyisocyanate-based):

SikaBiresin® F50 component A (from Sika), polyol mixture with about 25% by weight of aluminum hydroxide and about 5% by weight of molecular sieve.

SikaBiresin® F50 component B (from Sika), liquid MDI.

Sikadur® 514 Plus component C (from Sika), mixture of mineral fillers containing about 70% by weight of quartz and about 15% by weight of portland cement. 2.0 to 3.2 mm quartz sand, abbreviated to “QS”.

For the application, the liquid components A and B, the powder component C and quartz sand OS were mixed in a weight ratio A:B:C:QS=2:1:14:7 and processed within 30 min.

### Production of Laminates:

### Example 1

A number of laminates were produced under standard climatic conditions, in each case by positioning a 40×50×30 mm wood body made of beechwood on a horizontal base such that an area of 40×50 mm faced upward and the thickness was 30 mm. The surface was freed of dust by means of a brush.

The wood body thus provided was then clamped into a formwork mold that seamlessly surrounded the outer sides of the wood body and projected above the surface of the wood body by 30 mm, so as to form a casting mold for the curable composition of depth 30 mm.

Subsequently, the freshly mixed composition Z1 was placed into the casting mold in a layer thickness of 30 mm, such that it was completely filled, and the surface was smoothed using a brick trowel. The formwork was removed after 12 h under standard climatic conditions. This gave a 40×50×60 mm laminate.

A number of such laminates were stored for 28 d under standard climatic conditions and then subjected to a compressive shear strength test. Compressive shear strength was determined in accordance with DIN EN 392 on the bonded shear area of 50×40 mm, at a testing speed of 1 mm/s.

Further laminates of this kind were stored for 28 d under standard climatic conditions and then for 24 h at room temperature in water, and likewise subjected in the wet state to the compressive shear strength test.

Example 1, after storage under standard climatic conditions for 28 d, showed a compressive shear strength of 18 MPa (average of 5 laminates), with the fracture mainly in the wood layer.

After storage for 24 h in water, the wood layer was in each case distinctly swollen (increase in volume about 30%), but the laminate was otherwise intact. The compressive shear strength of the wet laminates was 7 MPa (average of 5 laminates), with the fracture in each case at the interface between composition Z1 and the wood.

### Examples 2 and 3

A number of laminates were produced under standard climatic conditions, in each case by positioning a 1020×60×30 mm wood body made of beechwood on a horizontal base such that an area of 1020×60 mm faced upward and the thickness was 30 mm.

For example 2, the wood surface was dedusted using a brush and then the freshly mixed composition Z1 was placed into the casting mold in a layer thickness of 30 mm, such that it was completely filled, and the surface was smoothed using a brick trowel.

For example 3, the wood surface was pretreated with Sika® Primer MR Fast (water-based two-component epoxy primer, from Sika). After a flashoff time of 24 h, the freshly mixed composition Z3 was placed into the casting mold in a layer thickness of 30 mm, such that it was completely filled, and the surface was smoothed using a brick trowel.

The formwork was removed after 12 h under standard climatic conditions. This gave a 1020×60×60 mm laminate composed of beechwood and the cured composition.

A number of such laminates were stored at 28 d under standard climatic conditions and then subjected to a 3-point bending test to DIN 512186 with a span width of 900 mm, an initial load of 5 N, and a testing speed of 5 mm/min, for determination of flexural strength and maximum deformation. In order to determine modulus of elasticity, further laminates of this kind were subjected to an identical test, except that the testing speed was 2 mm/min and the load range was 100 to 3200 N.

The results are reported in table 1.

By way of comparison (reference), an uncoated beechwood body of dimensions 1020×60×60 mm was subjected to the same tests, and the results are likewise reported in table 1.

TABLE 1
Results of the 3-point bending of examples 2 and 3 and reference

| | Example | | |
|---|---|---|---|
| | 2 | 3 | Reference |
| Curable composition | Z1 | Z3 | — |
| Organic binder basis | Epoxy resin | Polyisocyanate | — |
| Flexural strength [N/mm²] | 142 | 70 | 115 |
| Maximum deformation | 27 mm | 14 mm | 28 mm |
| Modulus of | 13 612 | 16 310 | 13 398 |
| elasticity [N/mm²] | | | |

### Examples 4 and 5

A number of laminates were produced under standard climatic conditions by positioning a beam of square-rod laminated wood of dimensions 5200×320×120 mm, made of glued square beechwood timbers (about 2000×40×40 mm), on a horizontal base such that an area of 5200×320 mm faced upward and the thickness was 120 mm. A formwork mold was mounted around the wooden beam, so as to result in a casting mold of depth 60 mm on the surface.

For example 4, the wood surface was dedusted using a brush and then the freshly mixed composition Z2 was placed into the casting mold in a layer thickness of 60 mm, such that it was completely filled, and the surface was smoothed using a brick trowel.

For example 5, the wood surface was pretreated with Sika® Primer MR Fast (water-based two-component epoxy primer, from Sika). After a flashoff time of 24 h, the freshly mixed composition Z4 was placed into the casting mold in a layer thickness of 60 mm, such that it was completely filled, and the surface was smoothed using a brick trowel.

The formwork was removed after 12 h under standard climatic conditions. A 5200×320×180 mm laminate composed of beechwood and the cured composition was obtained, without distortion in length, width or height. In particular, the laminate showed no shrinkage cracks and no warpage through shrinkage in the curable composition, also called “keying”, nor any breaking of the composition away from the wood surface after curing.

A number of such laminates, after storage for 28 d under standard climatic conditions, were subjected to 4-point bending with two pressure cylinders at a testing span of 5000 mm, where the distance between the pressure cylinders before the sample was laid on was in each case 1680 mm and distance between the pressure cylinders 1640 mm. The force-defamation relationship measured in the middle of the carrier was used to determine the flexural strength of the composite cross section (stiffness), the load-bearing capacity and maximum deformation on fracture (average of 2 laminates).

The results are reported in table 2.

TABLE 2
Results of the 4-point bending of examples 4 and 5

| | Example | |
|---|---|---|
| | 4 | 5 |
| Curable composition | Z2 | Z4 |
| Organic binder basis | Epoxy resin | Polyisocyanate |
| Load-bearing capacity [kN] | 148 | 152 |
| Maximum deformation | 131 mm | 125 mm |
| Stiffness [Nmm²] | 2.97 · 10¹² | 2.98 · 10¹² |
| Fracture profile (2 laminates) | 2x wood fracture | 1x wood fracture |
| | | 1x adhesive fracture |

1. A method of producing a laminate, comprising:
providing a wood body,
applying a curable composition in a liquid statethereto,
and curing the composition,
wherein the composition contains at least one organic binder and at least 80% by weight of mineral fillers, based on the overall composition.

2. The method as claimed in claim 1, wherein the curable composition comprises at least two separately packed components that are mixed before or during the applying of the liquid composition.

3. The method as claimed in claim 1, wherein the curable component is free of cement.

4. The method as claimed in claim 1, wherein the wood body consists of glued and/or interdigitated laminated wood consisting of laminas or square rods.

5. The method as claimed in claim 1, wherein the wood body has a thickness in the range from 10 to 300 mm.

6. The method as claimed in claim 1, wherein the wood body on application of the liquid curable composition has been provided with formwork elements on the outer sides, such that the composition remains on the wood body after the application and cannot flow away.

7. The method as claimed in claim 1, wherein the curable composition is applied in a layer thickness in the range from 10 to 300 mm.

8. The method as claimed in claim 1, wherein the composition is cured at ambient temperature, optionally under the action of moisture.

9. The method as claimed in claim 1, wherein the organic binder of the curable composition is selected from a) epoxy resins and curing agents for epoxy resins and b) polyisocyanates and crosslinkers for polyisocyanates.

10. The method as claimed in claim 2, wherein the curable composition comprises
a first component comprising at least one epoxy resin,
and a second component comprising the curing agent for epoxy resins, containing at least one polyamine having aliphatically bonded amino groups and at least 3 amine hydrogens,
and the mineral filler is present as a constituent of the first and/or second component and/or as a further component.

11. The method as claimed in claim 2, wherein the curable composition comprises
a first component comprising a crosslinker for polyisocyanates, containing at least one polyol having an average molecular weight of 250 to 2000 g/mol and an average OH functionality of 1.7 to 6,
and a second component comprising at least one polyisocyanate,
and the mineral filler is present as a constituent of the first and/or second component and/or as a further component.

12. The method as claimed in claim 1, wherein the curable composition contains at least 50% by weight of mineral fillers selected from quartz and slag, based on the overall composition.

13. A laminate obtained from the method as claimed in claim 1.

14. The laminate as claimed in claim 13, wherein it has a load-bearing capacity of at least 100 kN, determined on a laminate of dimensions 5200×320×180 mm composed of wood and the cured composition, where the wood layer has dimensions of 5200×320×120 mm and the cured composition dimensions of 5200×320×60 mm, by means of 4-point bending with two pressure cylinders at a testing span of 5000 mm, distance between the pressure cylinders before the sample was laid on in each case 1680 mm and distance between the pressure cylinders 1640 mm.

15. A method comprising applying the laminate as claimed in claim 13 as a component in building construction.
